(19) United States
(12) Patent Application Publication
(10) Pub. No.: US 2024/0250343 A1
(43) Pub. Date: Jul. 25, 2024

(54) BATTERY COOLING DEVICE

(71) Applicant: Isuzu Motors Limited, Yokohama-shi, Kanagawa (JP)

(72) Inventor: Yuta IKEDA, Fujisawa-shi, Kanagawa (JP)

(73) Assignee: Isuzu Motors Limited, Yokohama-shi, Kanagawa (JP)

(21) Appl. No.: 18/693,980

(22) PCT Filed: Sep. 14, 2022
(86) PCT No.: PCT/JP2022/034318

§ 371 Date: Mar. 21, 2024

(30) Foreign Application Priority Data
Sep. 22, 2021 (JP) 2021-154308

(51) Int. Cl. H01M 10/6568; H01M 10/613; H01M 10/625; H01M 50/213

(52) U.S. Cl. CPC H01M 10/6568; H01M 10/613; H01M 10/625; H01M 50/213

(57) ABSTRACT

This battery cooling device cools a battery using a heat sink having formed therein a flow channel through which a refrigerant flows. The flow passage includes unit flow passages having one end from which the refrigerant prior to cooling battery cells flows in, and another end from which the refrigerant after cooling the battery cells is discharged. The unit flow passages have a U-shape that is folded back with a width equal to or less than a cell width of the battery cells.

### TECHNICAL FIELD

The present disclosure relates to a battery cooling device for cooling a battery mounted in a vehicle.

### BACKGROUND ART

As a battery cooling device of a vehicle, a device in which a heat sink (cooler) is provided so as to be adjacent to a battery has been known (e.g., see Patent Literature (hereinafter, referred to as PTL) 1). In the heat sink, a channel through which a refrigerant flows is formed, so that the heat of the battery can be lowered by the refrigerant.

### CITATION LIST

### Patent Literature

PTL 1
Japanese Patent Application Laid-Open No. 2018-127087

### SUMMARY OF INVENTION

### Technical Problem

Incidentally, there is a problem in that unevenness of heat occurs in the conventional battery cooling device that cools a battery by circulating a refrigerant in a channel.

This problem will be briefly described with reference to FIGS. 1 to 3. FIGS. 1 and 2 are plan views of examples in which heat sink 20 is disposed so as to be adjacent to the lower surface of battery pack 10. In battery pack 10, a plurality of battery cells 11 is provided as illustrated in FIG. 3. The shading of shaded patterns in FIGS. 1 to 3 indicates temperature, and the darker pattern represents a higher temperature.

FIG. 1 illustrates a case where a channel (not illustrated) through which a refrigerant flows in one direction is formed in heat sink 20. The refrigerant flows into the channel from refrigerant inlet 20a and is discharged from refrigerant outlet 20b. In practice, the channel may be one, or a plurality of channels may be formed in parallel.

When a channel through which a refrigerant flows in one direction is formed as illustrated in FIG. 1, the temperature of the refrigerant becomes higher toward the downstream side, that is, toward refrigerant outlet 20b, and thus, the temperature of battery pack 10 becomes higher toward the right side in the drawing, as indicated with the shading in FIG. 1.

FIG. 2 illustrates a case where a U-shaped channel (not illustrated) is formed in heat sink 20. Specifically, the channel extends from refrigerant inlet 20a in the right direction, is folded at the right end, and further extends in the left direction toward refrigerant outlet 20b.

When a U-shaped channel is formed as illustrated in FIG. 2, the temperature of the refrigerant becomes higher toward the downstream side, that is, toward refrigerant outlet 20b, and thus, the temperature of battery pack 10 becomes higher toward the upper side in the drawing, as indicated with the shading in FIG. 2. Note that, in a case where the channel is not in a U-shape and is in a meander-shape, in which the channel is folded back a plurality of times in heat sink 20, the temperature of battery pack 10 also becomes higher toward the upper side in the drawing.

FIG. 3 is a perspective view of states of battery cells 11 in battery pack 10. The shading in FIG. 3 corresponds to a case where a channel through which a refrigerant flows in one direction is formed as in FIG. 1. It can be seen that the temperatures of battery cells 11 on the downstream side of the channel are higher.

As described above, in the conventional battery cooling device, unevenness of temperature occurs between the plurality of battery cells 11 provided in battery pack 10. Specifically, the temperatures of battery cells 11 disposed on the downstream side of the channel are higher than the temperatures of battery cells 11 disposed on the upstream side of the channel.

Incidentally, battery cell 11 degrades more quickly at higher temperatures. Thus, battery cells 11 on the downstream side of the channel degrade more quickly than battery cells 11 on the upstream side of the channel. Such uneven degradation of battery cells 11 in battery pack 10 leads to shortening of the life of the entire battery, which is not preferred.

The present disclosure has been made in consideration of the above points, and provides a battery cooling device capable of reducing unevenness of temperature between battery cells.

### Solution to Problem

One aspect of a battery cooling device of the present disclosure is a battery cooling device of a vehicle for cooling a battery by using a heat sink including a channel formed therein and through which a refrigerant flows, in which
the channel includes a unit channel in which the refrigerant before cooling a battery cell is introduced from one end of the unit channel and the refrigerant after cooling the battery cell is discharged from another end of the unit channel, and
the unit channel has a U-shape formed by folding to have a width equal to or shorter than a cell width of the battery cell.

### Advantageous Effects of Invention

According to the present disclosure, it is possible to reduce unevenness of temperature in a battery.

### BRIEF DESCRIPTION OF DRAWINGS

FIG. 1 illustrates temperature distribution in a case where a channel through which a refrigerant flows in one direction is formed in a heat sink;

FIG. 2 illustrates temperature distribution in a case where a U-shaped channel is formed in the heat sink;

FIG. 3 is a perspective view of states of battery cells in a battery pack;

FIG. 4 is a schematic perspective view of the main configuration of a battery cooling device according to an embodiment;

FIG. 5 is a schematic perspective view of a heat sink;

FIG. 6 is a schematic perspective view of an example in which the folded widths of unit channels are the same as the cell width;

FIG. 7 is a diagram for describing a configuration of a channel for introducing and discharging a refrigerant into and from unit channels, FIG. 7A is a schematic perspective view of a configuration of a refrigerant introduction system, and FIG. 7B is a schematic perspective view of a configuration of a refrigerant discharge system;

FIG. 8 is a schematic perspective view of the placement of pressure-equalization tanks;

FIG. 9A is a sectional view taken along line A-A of FIG. 7A, and FIG. 9B is a sectional view taken along line B-B of FIG. 7B; and

FIG. 10 is a schematic perspective view of a state in which the pressure-equalization tank is attached to the heat sink.

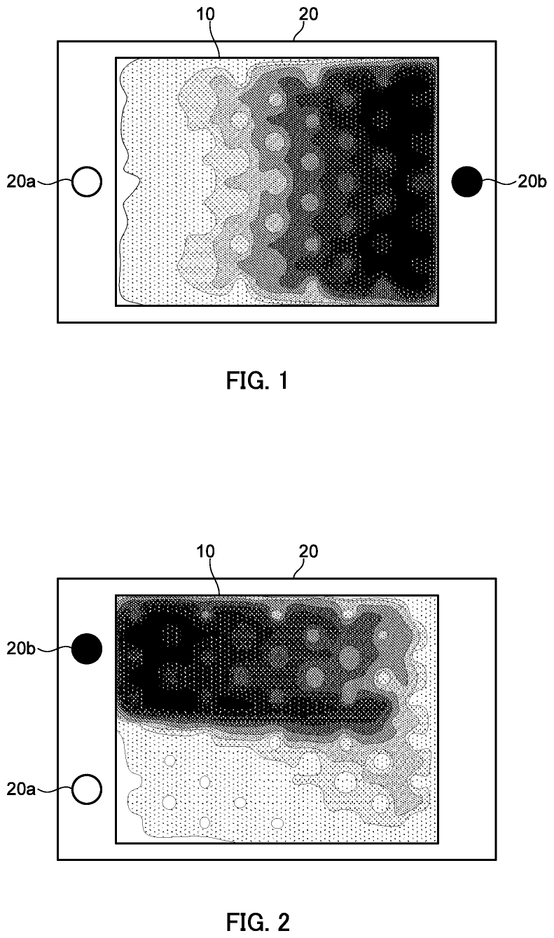

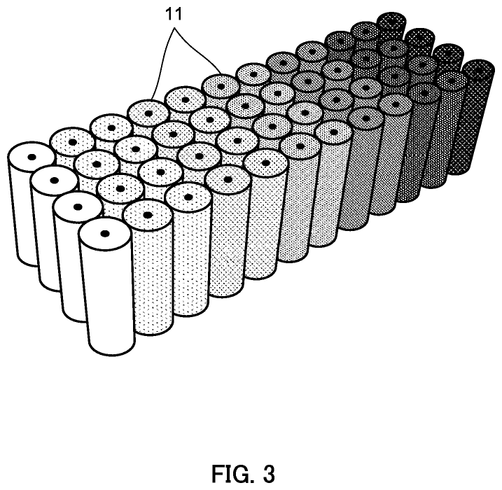

### DESCRIPTION OF EMBODIMENTS

Hereinafter, an embodiment of the present disclosure will be described in detail with reference to the drawings.

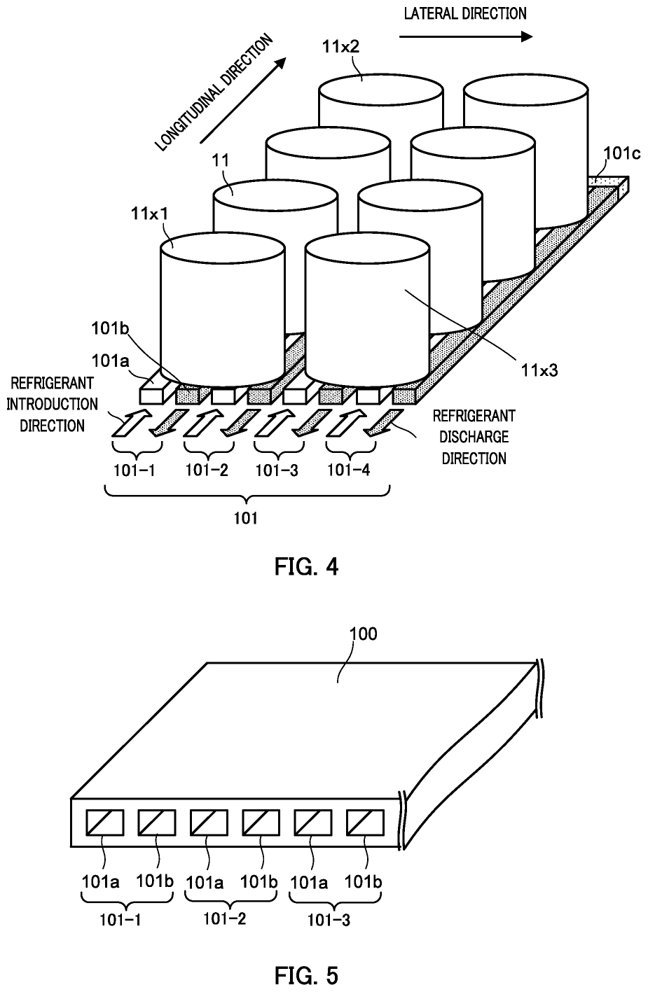

FIG. 4 is a schematic perspective view of the main configuration of a battery cooling device according to an embodiment. Since the main feature of the battery cooling device of the present embodiment is the shape and placement of the channel, FIG. 4 illustrates the positional relationship between channel 101 and battery cells 11.

First, a prerequisite configuration will be briefly described. A battery and a battery cooling device of the present embodiment are mounted in a vehicle. The battery includes a battery pack (not illustrated) and a plurality of battery cells 11 disposed in the battery pack. Channel 101 of the battery cooling device is disposed so as to be adjacent to the battery. In the present embodiment, channel 101 is disposed so as to be adjacent to the lower surface of the battery.

In practice, as illustrated in FIG. 5, channel 101 is formed in heat sink 100, and heat sink 100 is disposed so as to be adjacent to the battery. Channel 101 of heat sink 100 is formed by, for example, performing extrusion on an aluminum plate.

In the present embodiment, a plurality of unit channels 101-1, 101-2, 101-3, 101-4, and so forth is formed in heat sink 100. Each of unit channels 101-1, 101-2, 101-3, 101-4, and so forth has a U-shape formed by folding to have a width equal to or shorter than the cell width of battery cell 11. In practice, unit channels 101-1, 101-2, 101-3, 101-4, and so forth each have outward channel 101a, return channel 101b, and turning-back channel 101c.

Each of unit channels 101-1, 101-2, 101-3, 101-4, and so forth has a U-shape formed by folding to have a width equal to or shorter than the cell width of battery cell 11, so that one or more unit channels 101-1, 101-2, 101-3, 101-4, and so forth pass through each battery cell 11.

FIG. 4 illustrates an example in which the folded widths of unit channels 101-1, 101-2, 101-3, 101-4, and so forth are approximately ½ of the cell width. In this case, two of unit channels 101-1, 101-2, 101-3, 101-4, and so forth can pass through one battery cell 11.

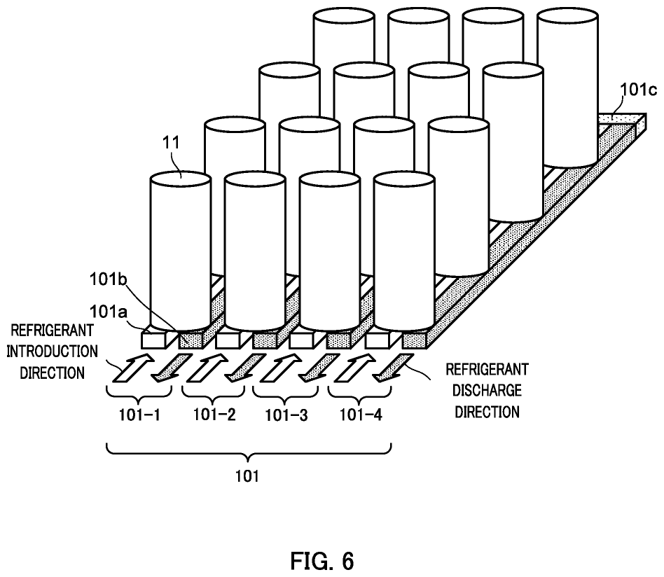

FIG. 6 illustrates an example in which the folded widths of unit channels 101-1, 101-2, 101-3, 101-4, and so forth are the same as the cell width. In this case, one of unit channels 101-1, 101-2, 101-3, 101-4, and so forth can pass through one battery cell 11.

As can be seen from FIGS. 4 and 6, the battery is configured by arranging a plurality of battery cells 11 in the battery pack in the longitudinal and lateral directions, unit channels 101-1, 101-2, 101-3, 101-4, and so forth each extend over the plurality of battery cells 11 in the longitudinal direction, and the plurality of unit channels is formed in the lateral direction. Further, one or more unit channels 101-1, 101-2, 101-3, 101-4, and so forth are formed for each battery cell in the lateral direction. Specifically, in the example of FIG. 4, two of unit channels 101-1, 101-2, 101-3, 101-4, and so forth are formed for each battery cell in the lateral direction, and in the example of FIG. 6, one of unit channels 101-1, 101-2, 101-3, 101-4, and so forth is formed for each battery cell in the lateral direction.

The refrigerant before cooling battery cells 11 flows from one end of each of unit channels 101-1, 101-2, 101-3, 101-4, and so forth, and the refrigerant after cooling battery cells 11 is discharged from the other end. As a refrigerant, pure water, a fluorine-based inert liquid, or the like is used, for example.

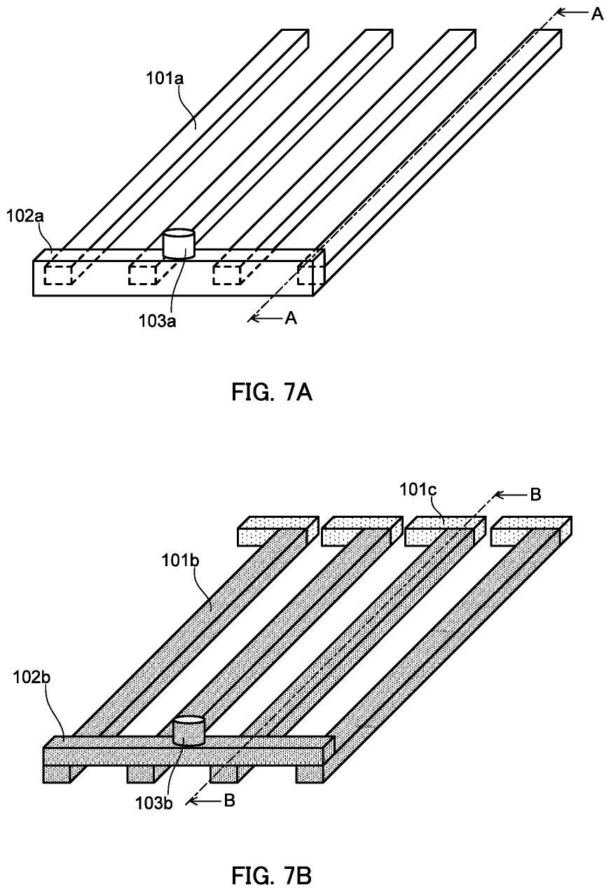

Next, the configuration of a channel for introducing and discharging the refrigerant into and from each of unit channels 101-1, 101-2, 101-3, 101-4, and so forth will be described. FIG. 7A is a schematic perspective view of a configuration of a refrigerant introduction system, and FIG. 7B is a schematic perspective view of the configuration of a refrigerant discharge system.

As can be seen from FIGS. 7A and 7B, pressure-equalization tank 102a is connected to end portions of outward channels 101a, and pressure-equalization tank 102b is connected to end portions of return channels 101b. In other words, first pressure-equalization tank 102a is connected to one end of each of a plurality of unit channels 101-1, 101-2, 101-3, 101-4, and so forth, and second pressure-equalization tank 102b is connected to the other end of each of the plurality of unit channels 101-1, 101-2, 101-3, 101-4, and so forth.

Pressure-equalization tank 102a includes an internal space that communicates refrigerant inlet 103a and a plurality of outward channels 101a with each other. The plurality of outward channels 101a is communicated with refrigerant inlet 103a by the same internal space, so that, when a refrigerant is introduced from refrigerant inlet 103a into the internal space of pressure-equalization tank 102a, the refrigerant flows into the plurality of outward channels 101a at the same pressure.

Similarly, pressure-equalization tank 102b includes an internal space that communicates refrigerant outlet 103b and a plurality of return channels 101b with each other. The plurality of return channels 101b is communicated with refrigerant outlet 103b by the same internal space, so that the refrigerant in the plurality of outward channels 101a is discharged at the same pressure.

As described above, by connecting pressure-equalization tank 102a to one end of each of a plurality of unit channels 101-1, 101-2, 101-3, 101-4, and so forth, and by connecting pressure-equalization tank 102b to the other end of each of the plurality of unit channels 101-1, 101-2, 101-3, 101-4, and so forth, the flow speed of the refrigerant in each of unit channels 101-1, 101-2, 101-3, 101-4, and so forth can be the same. Accordingly, the cooling performance between unit channels 101-1, 101-2, 101-3, 101-4, and so forth is equalized.

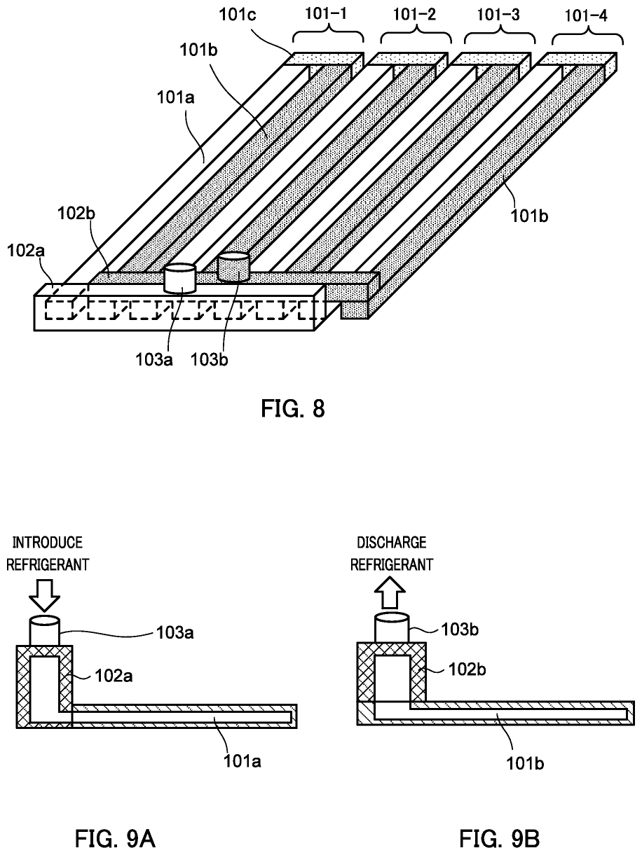

FIG. 8 is a schematic perspective view of the placement of pressure-equalization tanks 102a and 102b. As can be seen from the drawing, in the present embodiment, pressure-equalization tank 102a is disposed on the side surface of heat sink 100, and pressure-equalization tank 102b is disposed on the upper surface of heat sink 100. FIG. 9A is a cross-sectional view taken along line A-A of FIG. 7A, that is, taken along a plane including outward channel 101a, and FIG. 9B is a cross-sectional view taken along line B-B of FIG. 7B, that is, taken along a plane including return channel 101b.

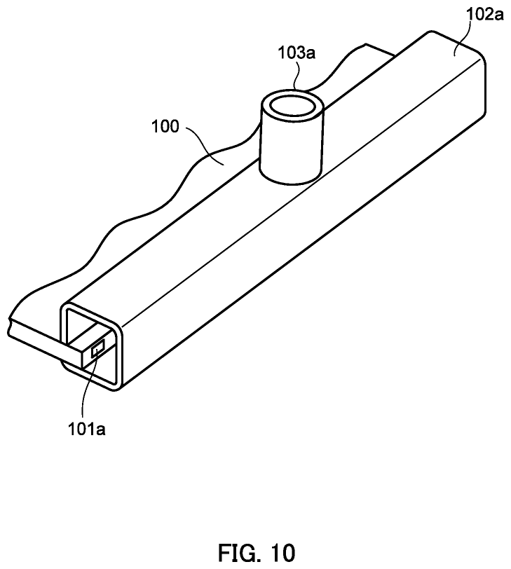

FIG. 10 is a schematic perspective view of a state in which pressure-equalization tank 102a is attached to heat sink 100.

In the above-described configuration, in the battery cooling device of the present embodiment, the refrigerant is supplied into pressure-equalization tank 102a from a refrigerant supply unit (not illustrated) through refrigerant inlet 103a. This refrigerant flows through the plurality of unit channels 101-1, 101-2, 101-3, 101-4, and so forth at the same flow speed by the action of pressure-equalization tanks 102a and 102b. The refrigerant whose temperature increases by flowing through the plurality of unit channels 101-1, 101-2, 101-3, 101-4, and so forth is discharged through pressure-equalization tank 102b and refrigerant outlet 103b.

At this time, battery cells 11 are cooled to approximately the same temperature regardless of the positions in the longitudinal and lateral directions. A description is given of this point with reference to FIG. 4.

First, the temperatures of battery cells 11 in the longitudinal direction will be described. As an extreme case, the temperature of battery cell 11x1 located at the position closest to the refrigerant inlet/outlet and the temperature of battery cell 11x2 located at the position closest to turning-back channel 101c are compared.

For battery cell 11x1, the refrigerant having the lowest temperature passes through outward channel 101a, and the refrigerant having the highest temperature passes through return channel 101b. Thus, it can be said that the cooling effect on battery cell 11x1 is moderate.

For battery cell 11x2, on the other hand, the refrigerant having the highest temperature passes though outward channel 101a, and the refrigerant having the lowest temperature passes through return channel 101b. Thus, it can be said that the cooling effect on battery cell 11x2 is moderate.

Therefore, the cooling of battery cell 11x1 and the cooling of battery cell 11x2 are performed to the same extent, and unevenness of temperature in the longitudinal direction does not occur.

Next, the temperatures of battery cells 11 in the lateral direction will be described. The temperature of battery cell 11x1 and the temperature of battery cell 11x3 are compared, for example.

Through both battery cell 11x1 and battery cell 11x3, the same numbers of outward channels 101a and return channels 101b pass, and thus the cooling of battery cell 11x1 and the cooling of battery cell 11x3 are performed to the same extent. Thus, unevenness of temperature in the lateral direction does not occur.

As described above, according to the present embodiment, in a battery cooling device of a vehicle for cooling a battery by using heat sink 100 including a channel formed therein and through which a refrigerant flows, the channel includes unit channels 101-1, 101-2, 101-3, 101-4, and so forth in which the refrigerant before cooling battery cells 11 is introduced from one end and the refrigerant after cooling battery cells 11 is discharged from the other end, and unit channels 101-1, 101-2, 101-3, 101-4, and so forth each have a U-shape formed by folding to have a width equal to or shorter than the cell width of battery cell 11.

This allows the realization of a battery cooling device capable of reducing unevenness of temperature between battery cells 11 and extending the battery life.

Further, according to the present embodiment, the battery is configured by arranging a plurality of battery cells 11 in a battery pack in the longitudinal and lateral directions, unit channels 101-1, 101-2, 101-3, 101-4, and so forth each extend over a plurality of battery cells 11 in the longitudinal direction, and the plurality of unit channels is formed in the lateral direction.

This can reduce unevenness of temperatures of battery cells 11 arranged in the longitudinal and lateral directions in both the longitudinal and lateral directions.

Further, according to the present embodiment, the battery cooling device includes: heat sink 100 in which a plurality of unit channels 101-1, 101-2, 101-3, 101-4, and so forth is formed; first pressure-equalization tank 102a connected to one end of each of the plurality of unit channels 101-1, 101-2, 101-3, 101-4, and so forth; and second pressure-equalization tank 102b connected to the other end of each of the plurality of unit channels 101-1, 101-2, 101-3, 101-4, and so forth. Unit channels 101-1, 101-2, 101-3, 101-4, and so forth are folded so as to have U-shapes in the surface direction of heat sink 100 having a plate shape, first pressure-equalization tank 102a is disposed on the side surface of heat sink 100, and second pressure-equalization tank 102b is disposed on the upper surface of heat sink 100.

Consequently, air bleeding can be easily performed when air enters into unit channels 101-1, 101-2, 101-3, 101-4, and so forth. That is, as can be seen from FIG. 9, the refrigerant outlet (FIG. 9B) from the channel (return channel 101b) is located at a higher position than the refrigerant inlet (FIG. 9A) to the channel (outward channel 101a), and the refrigerant outlet faces upward, so that, even when air enters into unit channels 101-1, 101-2, 101-3, 101-4, and so forth, this air is easily discharged from the refrigerant outlet.

The above-described embodiment merely describes an example of specific implementation for practicing the present disclosure, and should not be construed as limiting the technical scope of the present disclosure. That is, the present disclosure can be carried out in various forms without departing from the spirit and the main features thereof.

In the above-described embodiment, each of unit channels 101-1, 101-2, 101-3, 101-4, and so forth has been described as having a U-shape formed by folding to have a width equal to or shorter than the cell width, but the present disclosure is not limited thereto, and each of unit channels 101-1, 101-2, 101-3, 101-4, and so forth may have two or more U-shapes. That is, each of unit channels 101-1, 101-2, 101-3, 101-4, and so forth may be folded two or more times. However, it is preferred that each of unit channels 101-1, 101-2, 101-3, 101-4, and so forth fit within one cell width. Thus, it is preferred that the folded width be ½ of the cell width when the unit channel is folded twice, and that the folded width be ⅓ of the cell width when the unit channel is folded three times.

The disclosure of Japanese Patent Application No. 2021-154308, filed on Sep. 22, 2021, including the specification, drawings and abstract, is incorporated herein by reference in its entirety.

### INDUSTRIAL APPLICABILITY

The present disclosure is useful as a battery cooling device including a plurality of battery cells.

### REFERENCE SIGNS LIST

10 Battery Pack
11, 11x1, 11x2, 11x3 Battery cell
20, 100 Heat sink
20a, 103a Refrigerant inlet
20b, 103b Refrigerant outlet
101 Channel
101-1, 101-2, 101-3, 101-4 Unit channel
101a Outward channel
101b Return channel
101c Turning-back channel
102a, 102b Pressure-equalization tank

1. A battery cooling device of a vehicle for cooling a battery by using a heat sink including a channel formed therein and through which a refrigerant flows, wherein
the channel includes a unit channel in which the refrigerant before cooling a battery cell is introduced from one end of the unit channel and the refrigerant after cooling the battery cell is discharged from another end of the unit channel, and
the unit channel has a U-shape formed by folding to have a width equal to or shorter than a cell width of the battery cell.

2. The battery cooling device according to claim 1, wherein
the battery is configured by arranging a plurality of battery cells in a battery pack in a longitudinal direction and a lateral direction, and
the unit channel extends over the plurality of battery cells in the longitudinal direction, and a plurality of the unit channels is formed in the lateral direction.

3. The battery cooling device according to claim 2, wherein
at least one of the plurality of unit channels is formed for each of the plurality of battery cells in the lateral direction.

4. The battery cooling device according to claim 1, further comprising:
a heat sink having a plate shape in which a plurality of the unit channels is formed;
a first pressure-equalization tank connected to one end of each of the plurality of unit channels; and
a second pressure-equalization tank connected to another end of each of the plurality of unit channels, wherein
the plurality of unit channels are each folded so as to have a U-shape in a surface direction of the heat sink having a plate shape,
the first pressure-equalization tank is disposed on a side surface of the heat sink, and
the second pressure-equalization tank is disposed on an upper surface of the heat sink.
